(19) United States
(12) Patent Application Publication
(10) Pub. No.: US 2018/0364433 A1
(43) Pub. Date: Dec. 20, 2018

(54) Continuously Transposed Conductor With Embedded Optical Fiber

(71) Applicant: Essex Group, Inc., Atlanta, GA (US)

(72) Inventors: Matthew Leach, Fort Wayne, IN (US); Gregory S. Caudill, Fort Wayne, IN (US)

(21) Appl. No.: 16/008,455

(22) Filed: Jun. 14, 2018

Related U.S. Application Data
(60) Provisional application No. 62/520,130, filed on Jun. 15, 2017.

(51) Int. Cl. G02B 6/44; H01B 9/00

(52) U.S. Cl. CPC G02B 6/4416; H01B 9/006; H01B 9/005; G02B 6/443

(57) ABSTRACT

Continuously transposed conductor cables include a plurality of electrically insulated strands that are formed into two interposed stacks. Each of the plurality of strands may successively and repeatedly taking on each possible position with a cross-section of the CTC cable. Additionally, an optical fiber may be incorporated into the continuously transposed conductor cable.

### CROSS-REFERENCE TO RELATED APPLICATION

This application claims priority to U.S. Provisional Application No. 62/520,130, filed Jun. 15, 2017 and entitled “Continuously Transposed Conductor with Embedded Optical Fiber,” the contents of which is incorporated by reference herein in its entirety.

### TECHNICAL FIELD

Embodiments of the disclosure relate generally to continuously transposed conductors and, more particularly, to continuously transposed conductors that include one or more embedded optical fibers.

### BACKGROUND

Continuously transposed conductors (“CTCs”) and/or CTC cables include a number of multiple parallel strands that are individually insulated and formed into an assembly. Typically, the strands of a CTC cable are formed into two interposed stacks, and each strand is transposed in turn to each position within the cable. Each strand may successively and repeatedly take on each possible position within a cross-section of the CTC cable. CTC cables are typically used to form windings in electrical devices, such as electrical transformers.

CTC cables are typically used as winding wires in power transformers. In certain applications, it is desirable to perform temperature sensing or other sensing within a power transformer. In conventional applications, optical fiber sensors are integrated into power transformers independent of a winding formed from CTC cable in order to monitor temperature and strain. However, the use of separate sensors increases manufacturing steps and costs. Further, it may be more likely that separate fiber sensors are damaged within a transformer. Accordingly, there is an opportunity for improved CTC cables that include or incorporate one or more optical fibers suitable for sensing.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1 is a perspective view of an example CTC cable that includes at least one optical fiber, according to an illustrative embodiment of the disclosure.

FIGS. 2A-2D illustrate example optical fibers and/or optical fiber components that may be incorporated into CTC and/or other cables, according to illustrative embodiments of the disclosure.

FIGS. 3A and 3B are cross-sectional views of example CTC cables that include optical fibers positioned within or under an outer wrap, according to illustrative embodiments of the disclosure.

FIG. 4 is a cross-sectional view of an example CTC cable that includes one or more optical fibers incorporated into a separator, according to an illustrative embodiment of the disclosure.

FIG. 5 is a cross-sectional view of an example CTC cable that includes at least one optical fiber incorporated into a strand, according to an illustrative embodiment of the disclosure.

FIG. 6 is a cross-sectional view of an example CTC cable that includes at least one optical fiber incorporated into a multi-conductor strand, according to an illustrative embodiment of the disclosure.

FIGS. 7A-7F are cross-sectional views of example conductors that include at least one optical fiber and that may be utilized within a transformer, according to illustrative embodiments of the disclosure.

### DETAILED DESCRIPTION

Various embodiments of the present disclosure are directed to continuously transposed conductors (“CTCs”) and/or CTC cables that include one or more embedded or otherwise incorporated optical fibers. The optical fiber(s) may be utilized to conduct temperature, stress, vibration, and/or other monitoring within a transformer or other application that incorporates the CTC cables. For example, a CTC cable may be utilized to form a winding within a suitable transformer, such as a power transformer, a liquid filled transformer, a dry type transformer, etc. An optical liber incorporated into the CTC cable may then be connected to a suitable monitoring device or system and utilized to monitor one or more conditions within the transformer.

One or more optical fibers may be incorporated into a CTC cable at a wide variety of suitable locations or positions. In certain embodiments, one or more optical fibers may be positioned under or within an outer wrap formed around a CTC cable. In other embodiments, one or more optical fibers may be positioned between two stacks of strands in a CTC cable, for example, within a separator positioned between the two stacks. In yet other embodiments, an optical fiber maybe incorporated into a single-conductor or into a multi-conductor strand that is utilized in the CTC cable. For example, an optical fiber may be embedded in an extruded insulation layer, in a bonding layer, or within a conductor itself. As desired, respective optical fibers may be incorporated into a plurality of conductors and/or strands. In yet other embodiments, a plurality of optical fibers may be incorporated into a CTC cable using any suitable combination of the techniques discussed herein.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

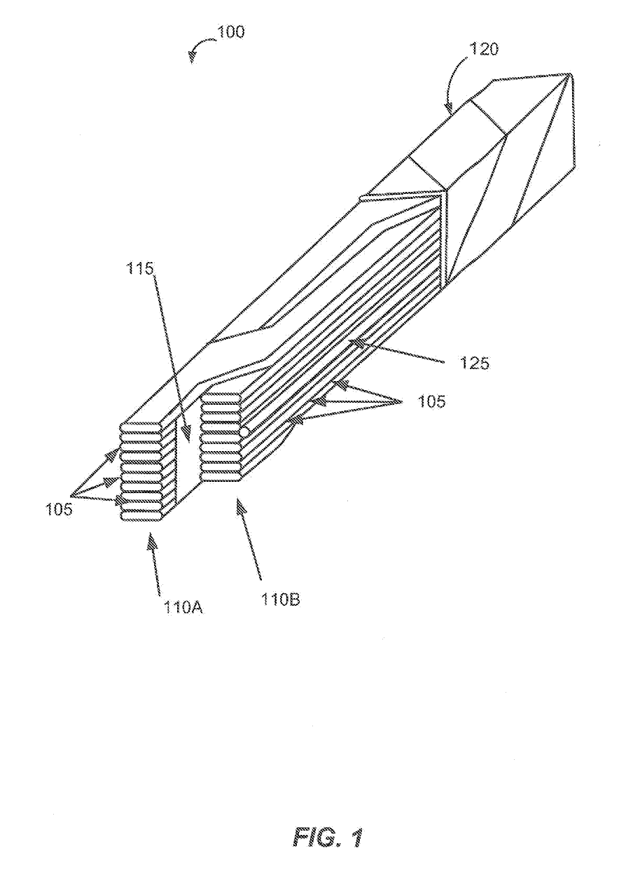

With reference to FIG. 1, a perspective view of an example CTC cable 100 is illustrated in accordance with an embodiment of the disclosure. The CTC cable 100 (also referred to as a multiple parallel conductor cable) may be formed from a plurality of strands 105 or partial conductors. In certain embodiments, each strand may include a single individually insulated conductor. In other embodiments, one or more strands may include a plurality of conductors, such as a plurality of individually insulated conductors that have been bonded together.

As shown in FIG. 1, the strands 105 may be arranged into two stacks, such as side-by-side stacks 110A, 110B. At least a portion of the strands 105 may then be interposed between the two stacks 110A, 110B. For example, a top strand from a first stack 110A may be transposed to the second stack 110B and/or a bottom strand from the second stack 110B may be transposed to the first stack 110A. The positions of the other strands may be adjusted (e.g., shifted up or down within a stack) as transpositions are made. In certain embodiments, the strands 105 may be interposed such that each strand successively and repeatedly takes on each possible position within a cross-section, of the CTC cable 100. As desired, the pitch of each transposition (i.e., a longitudinal distance required to complete a transposition of a strand from one stack to another stack) and the number of strands in the assembly may be selected and/or optimized in order to account for a wide variety of suitable factors, such as a desired rotation of the CTC, one or more dimensions associated with a desired application (e.g., the length of a stator slot, a slot width, an end-winding area, an end-winding diameter, etc.), and/or the capabilities of one or more manufacturing processes. The transpositions may assist in reducing or limiting the circulating currents and/or circulating losses within the CTC cable 100. Additionally, in certain embodiments, the plurality of strands 105 may be connected in parallel at their ends.

A separator 115 may optionally be positioned between the two stacks 110A, 110B. The separator 115 may be formed from a wide variety of suitable materials and/or combinations of materials. For example, the separator 115 may be formed from paper (e.g., natural paper, thermally upgraded paper, cellulose paper, calendared paper, crepe paper, aramide paper, etc.), Kraft paper, cardboard, various plastics, one or more polymeric materials, one or more thermoplastic resins (e.g., any of the resins described below for example strand insulation, etc.), Nomex, Kevlar, glass tape, glass fabric tape, one or more semi-conductive materials (e.g., materials that incorporate carbon, etc.), one or more dielectric shielding materials (e.g., barium ferrite, etc.) or any other suitable material, or combination of materials. A separator 115 may be formed with a wide variety of suitable dimensions, such as any suitable longitudinal length, thickness, (e.g., a thickness that defines a separation distance between the two stacks 110A, 110B), and/or width (e.g., a width along a direction between the two stacks 110A, 110B perpendicular to a longitudinal direction and thickness of the separator).

Additionally, in certain embodiments, an outer sheath 120 may be formed around the two stacks 110A, 110B and, if present, the separator 115. The outer sheath 120 may provide mechanical strength, mechanical protection, and/or dielectric strength. In certain embodiments, the outer sheath 120 may be formed from one or more suitable tapes or other wraps that are wound or otherwise wrapped around the two stacks 110A, 110B at any suitable angle. As desired, a tape or wrap may overlap itself as it is wound around the two stacks 110A, 110B. For example, each successive wrapping may overlap a previous wrapping such that no gaps are formed in the wrapped layer. Additionally, in certain embodiments, a plurality of tape or wrap layers may be formed, for example, as stacked or successive layers, and each tape may be wrapped in the same direction. In other embodiments, tapes or wraps may be wrapped in opposite direction. For example, two wraps (e.g., two Nomex wraps, etc.) may be wrapped in opposite direction to form an overall diamond wrap with gaps or spaces that allow oil to flow through CTC strands 105 for cooling purposes. In yet other embodiments, one or more perforated tapes or wraps may be utilized. In other embodiments, an outer sheath 120 may be formed from one or more layers of extruded material, for example, one or more layers of extruded polymeric material. In yet other embodiments, an outer sheath 120 may be formed from a combination of tape layers and/or extruded layers.

A wide variety of suitable materials may be utilized to form an outer sheath 120. For example, an outer sheath may be formed from paper (e.g., natural paper, thermally upgraded paper, cellulose paper, calendared paper, crepe paper, aramide paper, etc.), Kraft paper, cardboard, various plastics, Nomex, Kevlar, glass tape, glass fabric tape, one or more polymeric materials, one or more thermoplastic resins (e.g., any of the resins described below for example strand insulation, etc.), one or more semi-conductive materials (e.g., materials that incorporate carbon, etc.), one or more dielectric shielding materials (e.g., barium ferrite, etc.) or any other suitable material or combination of materials. Additionally, an outer sheath 120 may be formed with a wide variety of suitable dimensions, such as any suitable thickness. As desired, a tape or wrap utilized in an outer sheath 120 may also be formed with a wide variety of suitable dimensions, such as any suitable width and/or thickness.

The CTC cable 100 may be formed with any suitable number of strands 105 as desired in various embodiments. In certain embodiments, the CTC cable 100 may be formed with approximately 3, 5, 6, 7, 11, 15, 19, 25, 30, 40, 50, 60, 72, 81, or 85 strands, or a number of strands included in a range between any two of the above values. For example, the CTC cable 100 may be formed with between approximately five (5) and approximately eighty-five (85) strands. In certain embodiments, the number of strands utilized may be based at least in part upon any number of application-specific factors including, but not limited to, the size of the strands, a length of a slot into which the CTC cable 100 is inserted, a desired degree of rotation of the CTC cable 100, etc. Any number of suitable strands 105 may be transposed at a time. For example, one or two strands may be transposed at a time. As desired, one or more strands may be transposed with any suitable pitch and/or with any suitable configuration.

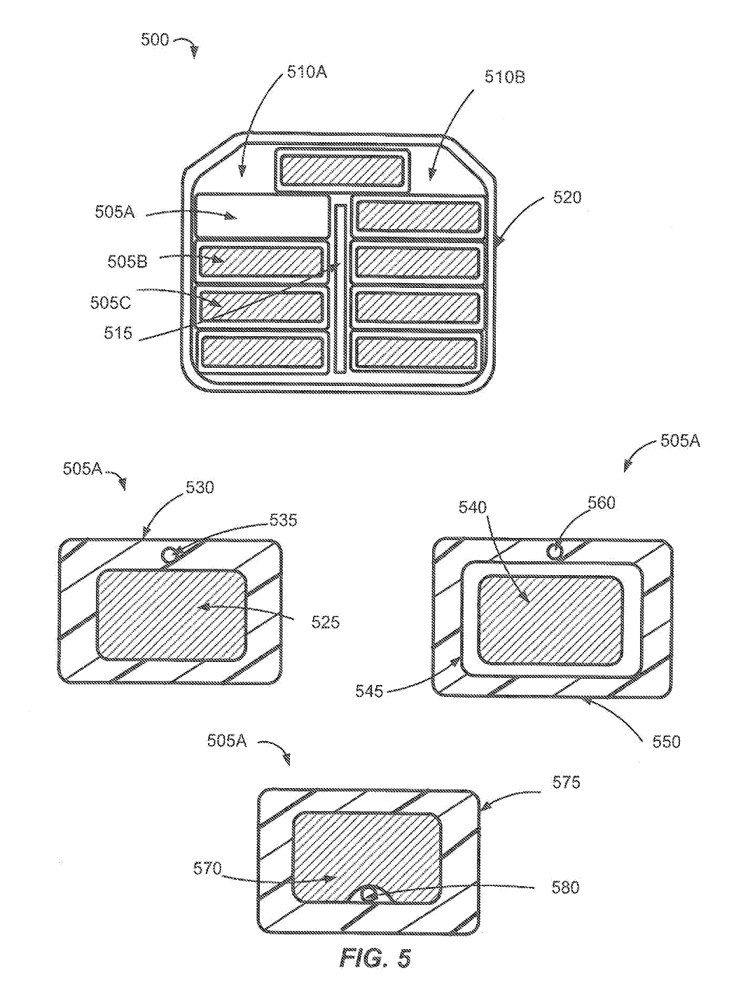

Each strand (hereinafter referred to individually as strand 105) may include one or more insulated conductors. In certain embodiments, a strand 105 may be formed with a single insulated conductor. In other embodiments, as illustrated in FIG. 5, a strand 105 may include a plurality of conductors. A strand conductor may be formed from a wide variety of suitable materials and/or combinations of materials. For example, a conductor may be formed from copper, aluminum, annealed copper, oxygen-free copper, silver-plated copper, silver, gold, a conductive alloy, carbon nanotubes, carbon polyimide composite materials, or any other suitable electrically conductive material. Additionally, the conductor may be formed with any suitable dimensions and/or cross-sectional shapes. As shown, a conductor may have a rectangular cross-sectional shape. However, a conductor may be formed with a wide variety of other cross-sectional shapes, such as a square shape, an elliptical or oval shape, etc. Additionally, as desired, a conductor may have corners that are rounded, sharp, smoothed, curved, angled, truncated, or otherwise formed.

A conductor may also be formed with any suitable dimensions. For example, a rectangular conductor may include longer dimensions of approximately 0.01, 0.02, 0.03, 0.04, 0.05, 0.1, 0.2, 0.25, 0.3, 0.4, 0.5, 0.6, 0.7, 0.8, 0.9, or 1.0 inches, a dimension included in a range between any two of the above values, or a dimension included in a range bounded on either a minimum or maximum end by one of the above values. Similarly, a rectangular conductor may include shorter dimensions of approximately, 0.005, 0.01, 0.02, 0.03, 0.04, 0.05, 0.06, 0.07, 0.08, 0.09, 0.1, 0.125, 0.15, 0.175, 0.2, 0.25, 0.3, 0.4, or 0.5 inches, a dimension included in a range between any two of the above values, or a dimension included in a range bounded, on either a minimum or maximum end by one of the above values. Other suitable dimensions may be utilized as desired, and the described dimensions are provided by way of example only. Additionally, a conductor may be formed with any suitable cross-sectional area. Similarly, a strand 105 may be formed with any suitable dimensions, such as any suitable cross-sectional shape, thickness, width, etc. In certain embodiments, a strand 105 may include dimensions that are combined dimensions of a conductor and insulation formed around the conductor. For example, a thickness of a strand may be defined as the thickness of a conductor combined with twice the thickness of the conductor insulation.

Each strand 105 may also include insulation material formed around the one or more conductors of the strand 105. A wide variety of suitable insulation materials and/or combinations of insulation materials may be utilized as desired in various embodiments. Additionally, as desired, a single layer or a plurality of layers of insulation material may be formed around a conductor. For example, in certain embodiments, the insulation material may include one or more layers of enamel. An enamel layer is typically formed by applying polymeric varnish to the conductor and then baking it in a suitable enameling oven or furnace. As desired, multiple layers of enamel maybe applied to the conductor until a desired number of enamel coats have been applied and/or until a desired enamel thickness or build has been achieved.

A wide variety of different types of polymeric materials may be utilized as desired to form an enamel layer. Examples of suitable materials include, but are not limited to, polyvinyl acetal-phenolic, polyimide, polyamideimide, amideimide, polyester, polyesterimide, polysulfone, polyphenylenesulfone, polysulfide, polyphenylenesulfide, polyetherimide, polyamide, etc. In certain embodiments, a polyimide-based material (e.g., polyimide, polyamideimide, etc.) maybe utilized, as these materials typically have relatively high heat resistance. Additionally, in certain embodiments, an enamel layer may be formed as a mixture of two or more materials. Further, in certain embodiments, different enamel layers may be formed from the same material(s) or from different materials. For example, a first layer of enamel may be formed from a first material, and a second layer of enamel may be formed from a second material.

In other embodiments, the insulation may include one or more suitable wraps or tapes, such as a polymeric tape, a polyester wrap, or a polyester glass wrap. For example, a polyimide tape or other suitable tape may be utilized. As desired, additional materials or additives (e.g., another polymeric material, etc.) may be incorporated into, embedded into, or adhered to a tape. Additionally, a tape may include a wide variety of suitable dimensions, such as any suitable thickness and/or width. In yet other embodiments, the insulation material may be formed as extruded insulation material. An extrusion process may result in the formation of an insulation layer from approximately 100% solid material. In other words, an extruded insulation layer may be substantially tree of any solvents. As a result, the application of an extruded layer may be less energy intensive than the application of enamel layers as there is no need to evaporate solvents. In certain embodiments, a single layer may be extruded to form insulation material. In other words, a single extrusion step may be performed during formation of the insulation material. In other embodiments, the extruded insulation material may be formed via a plurality of extrusion steps to include a plurality of layers. Any number of layers may be utilized as desired, such as two, three, four, or more layers. As desired, each layer may be formed from the same material or, alternatively, at least two layers may be formed from different materials. Additionally, as desired in certain embodiments, one or more other suitable materials may be positioned between layers of extruded materials, such as adhesives, other insulation materials, etc.

A wide variety of suitable materials and/or combination of materials may be utilized as desired to form extruded insulation. In certain embodiments, extruded insulation may be formed from one or more suitable polymeric materials, thermoplastic resins or materials, fluoropolymers and/or other suitable materials. For example, the extruded insulation may be formed from and/or may include at least one of polysulfone, polyphyenylsulfone (“PPSU”), polysulfide, polyphenylene sulfide (“PPS”), polyetherketone (“PEK”), polyether-ether-ketone (“PEEK”), polyaryletherketone (“PAEK”), polyamide etherketone, thermoplastic polyimide, aromatic polyamide, extruded polyester, extruded polyketone, fluorinated ethylene propylene (“FEP”), polytetrafluoroethylene (“PTFE” such as Teflon®, etc.), perfluoroalkoxy alkane (“PFA”), ethylene tetrafluoroethylene (“ETFE”), etc. Additionally, extruded insulation material may be formed as a single material, a co-polymer, a blend of materials, or as any other suitable combination of materials. For example, the extruded material may contain a plurality of materials, such as one or more thermoplastic resin materials (e.g., PEEK, PAEK, etc.) in combination with one or more fluoropolymers (e.g., “PTFE”, etc.).

In other embodiments, a plurality of different types of insulation material may be formed on a strand. For example, an extruded layer of material may be formed around one or more layers of enamel. Indeed, a wide variety of different combinations of insulation material may be utilized. Further, other types of materials and/or layers of material may be incorporated into strand insulation in other embodiments. For example, one or more semi-conductive layers (e.g., semi-conductive enamel layers, enamel layers including semi-conductive filler material, extruded semi-conductive layers, etc.) may be incorporated into the insulation. In certain embodiments, a semi-conductive layer may be formed from a material that combines one or more suitable filler materials with one or more base materials. Examples of suitable filler materials include, but are not limited to, suitable inorganic materials such as metallic materials and/or metal oxides (e.g., zinc, copper, aluminum, nickel, tin oxide, chromium, potassium titanate, etc.), and/or carbon black; suitable organic materials such as polyaniline, polyacetylene, polyphenylene, polypyrrole, other electrically conductive particles; and/or any suitable combination of materials. One or more semi-conductive layers may assist in equalizing voltage stresses in the insulation and/or dissipating corona discharges at or near the conductor. This dissipation or bleeding off of corona discharges and/or electrical stresses may improve dielectric performance and/or increase the partial discharge inception voltage (“PDIV”) of a strand 105.

The insulation material, or any given layer of the insulation material, may be formed with any suitable thickness as desired in various embodiments. For example, insulation material may be formal with a thickness of approximately 0.001, 0.002, 0.003, 0.005, 0.006, 0.008, 0.01, 0.015, 0.02, 0.03, 0.04, 0.05, 0.06, 0.07, 0.08, 0.09, 0.10, 0.12, or 0.15 inches, a thickness included in a range between any two of the above values, or a thickness included in a range bounded on either a minimum or maximum end by one of the above values. Other thicknesses may be utilized as desired. Additionally, in certain embodiments, the insulation material may be formed to have a cross-sectional shape that is similar to that of the underlying conductor. For example, if the conductor has an approximately rectangular cross-sectional shape, the insulation material may be formed to preserve the approximately rectangular cross-sectional shape of the insulated conductor. In other embodiments, the insulation material may be formed such that the cross-sectional shape of the underlying conductor is not preserved. In other words, the insulated conductor may have a different cross-sectional shape than the underlying conductor. As one non-limiting example, the conductor may be formed with an elliptical cross-sectional shape while the insulation material is formed in a way that leads to an approximately rectangular cross-sectional shape of the insulated conductor. A wide variety of other suitable configurations will be appreciated.

As desired, application of one or more insulation layers may be controlled to result in any desired concentricity. The concentricity of the insulation material is the ratio of the maximum and minimum thickness of the material at any given cross-sectional point along a longitudinal length of the strand 105. In certain embodiments the insulation material may be formed with a concentricity between approximately 1.0 and approximately 1.8. For example, the insulation material may be formed with a concentricity of approximately 1.0, 1.01, 1.02, 1.03, 1.04, 1.05, 1.07, 1.09, 1.1, 1.2, 1.3, 1.4, 1.5, 1.6, 1.7, 1.8, a concentricity included in a range between any two of the above values, or a concentricity bounded on a maximum end by any one of the above values.

In certain embodiments, insulation material may be formed completely around a strand conductor. In other embodiments, insulation material may be formed partially around a conductor. For example, insulation material may be selectively formed on edges or surfaces of a strand 105 that may contact one or more adjacent strands when the strands are incorporated into a CTC cable or multiple parallel conductor. In this regard, an amount of utilized insulation material and overall cost of a CTC cable may be reduced.

Although the example strands 105 illustrated in FIG. 1 incorporate a single conductor, in certain embodiments, a strand may include a plurality of individually insulated conductors. For example, a plurality of individually insulated conductors may be bonded together in order to form a strand. As another example, insulation material (e.g., extruded insulation material, etc.) may be formed around two conductors in order to form a single strand with individually insulated conductors.

In the event that a plurality of individually insulated strands are bonded or joined together, a wide variety of suitable materials and/or combination of materials may be utilized to form a joining coating. These materials include, but are not limited to, epoxy materials, thermoplastic resins, extruded materials, and/or adhesive materials. In certain embodiments, the joining coating may be formed between and/or around the two conductors. In other embodiments, the joining coating may be formed between and partially around (e.g., at least partially along the flat surfaces of rectangular substrands, etc.) the two conductors. In yet other embodiments, the joining coating may be formed between the two conductors. Indeed, a wide variety of joining coating configurations may be utilized. In yet other embodiments, a separate joining coating may not be utilized. For example, when extruded insulation material is formed, the extruded material may be formed between and/or around the conductors in order to both individually insulate and join the conductors.

Any number of conductors or substrands may be incorporated into a multi-conductor strand. Additionally, the conductors may be arranged in a wide variety of suitable configurations. For example, two rectangular conductors may be arranged in a side by side configuration with their narrower sides adjacent to one another. As another example, two rectangular conductors may be arranged in a flat by flat configuration with their longer sides adjacent to one another. In other examples, four, six, eight, or any other suitable number of conductors may be arranged in one or more rows and/or columns within a strand 105. As a result of incorporating a plurality of conductors into a strand 105, it may be possible to produce a CTC cable with a higher number of total conductors without adding significant additional cost or requiring improved stranding equipment.

In certain embodiments, one or more bond layers or bond coatings may additionally be formed on a portion or all of the strands 105. The bond layer(s) may facilitate future thermosetting of the strands 105, for example, when the CTC cable 100 is incorporated into an electrical device. The bond layer(s) may include one or more layers of a suitable material that facilitates thermosetting of a strand 105. In an example CTC cable 100, approximately ninety percent (90%) or more of the strands may include a bond layer. A bond layer may be formed at least partially around a CTC strand 105. Additionally, a bond layer may be formed from a material that has a lower melt temperature than the primary insulation of the strand 105. In this regard, once a winding or other desired structure is formed from the CTC cable 100, the cable may be heated in such a manner that the bond layer is activated to assist in maintaining a desired structural shape.

A bond layer may be formed from a wide variety of suitable materials and/or combination of materials. In certain embodiments, the bond layer may be formed from an epoxy coating, hot melt adhesive, or any other suitable thermosetting material. Examples of suitable materials that may be utilized to form a bond layer include, but are not limited to, penoxy resin, cross-linking phenoxy, phenoxy associates, polysulfone, and/or similar materials. Additionally, a bond layer may be formed with any suitable thickness, for example a thickness between approximately 0.0005 inches (13 μm) and approximately 0.010 inches (254 μm). Other thicknesses may be utilized as desired.

With continued reference to FIG. 1, according to an aspect of the disclosure, one or more optical fibers 125 may be incorporated into the CTC cable 100. The optical fiber(s) 125 may be utilized to conduct temperature, stress, vibration, and/or other monitoring within a transformer or other application that incorporates the CTC cable 100. For example, the CTC cable 100 may be utilized to form a winding within a power transformer. An optical fiber 125 incorporated into the CTC cable 100 may then be connected to a suitable monitoring device or system and utilized to monitor one or more conditions within the power transformer.

In certain embodiments, a single optical fiber 125 may be incorporated into the CTC cable 100. In other embodiments, a plurality of optical fibers 125 may be incorporated into the CTC cable 100. For example, a plurality of optical fibers 125 may be positioned at a single location (e.g., within a CTC cable component such as a separator 115, within an optical fiber component such as a microtube or ribbon, etc.). As another example, a plurality of optical fibers 125 may be positioned at a plurality of different locations. Each optical fiber 125 utilized in the CTC cable 100 may be a single mode fiber, bend insensitive single mode fiber, multi-mode fiber, bend insensitive multi-mode fiber, multi-core fiber, or some other optical waveguide that carries data optically. An optical fiber 125 may also include any suitable composition and/or may be formed from a wide variety of suitable materials capable of forming an optical transmission media, such as glass, one or more glassy substances, one or more silica materials, one or more plastic materials, or any other suitable material or combination of materials. Each optical fiber may also have any suitable cross-sectional diameter or thickness.

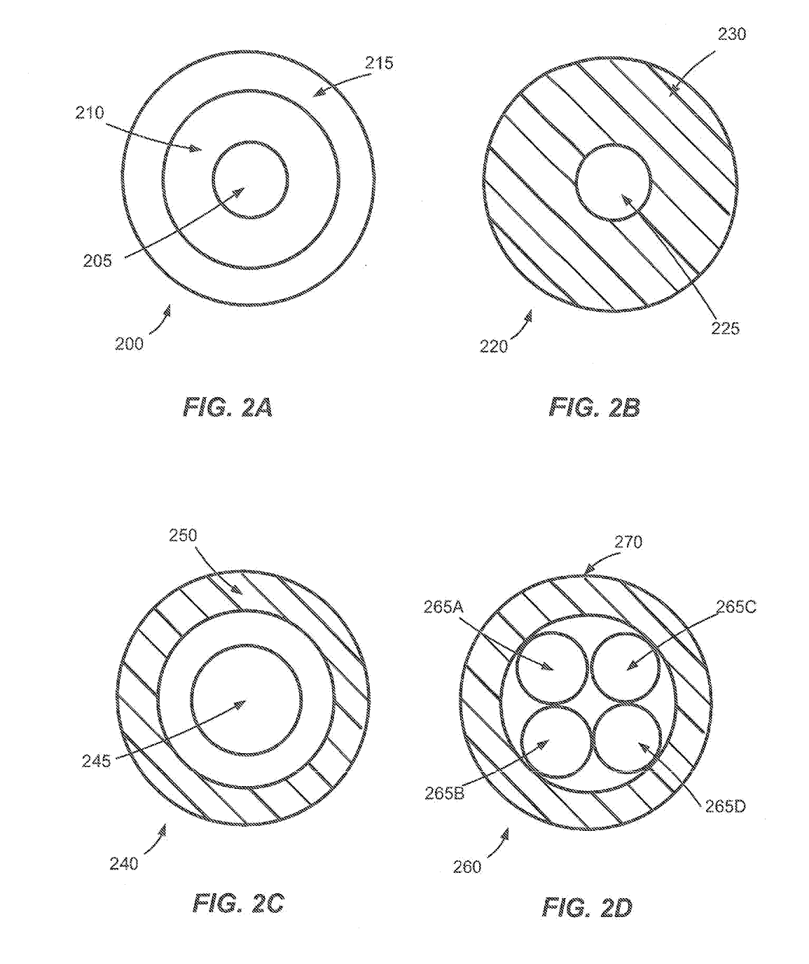

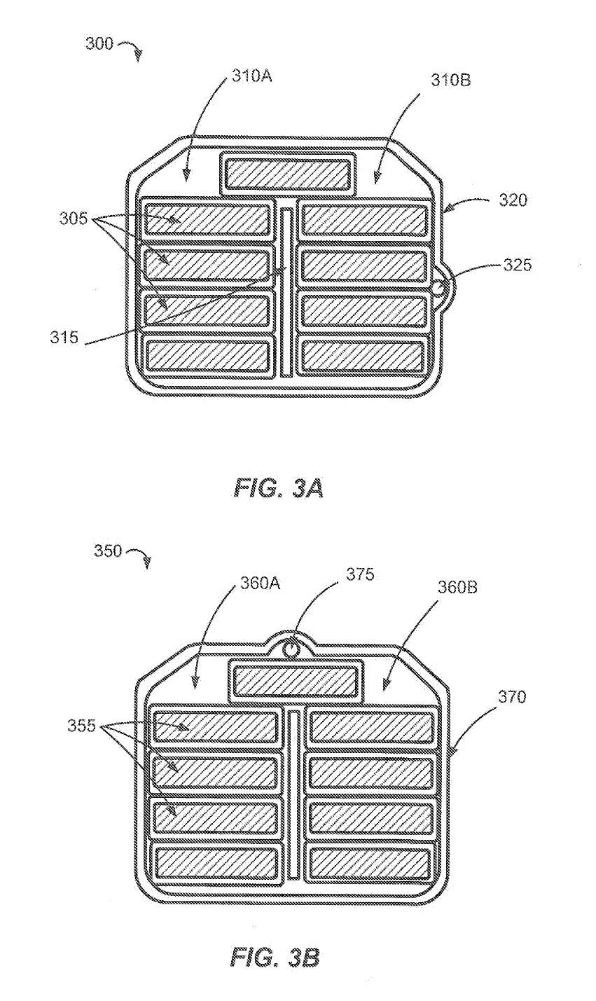

An example optical fiber 125 incorporated into a CTC cable 100 may include a wide variety of suitable constructions, protective layers, buffer layers, and/or tubes. A few example optical fiber constructions and/or optical fiber components are described with reference to FIGS. 2A-2D. These example fiber constructions may be incorporated into any of the example CTC cables and/or other cables described herein, such as the CTC cable 100 of FIG. 1 and/or any of the example cables described with reference to FIGS. 3-7F. Turning first to FIG. 2A, an example optical fiber 200 is illustrated without any separate buffer layers. The optical fiber 200 may include at least one core 205 and a cladding 210 formed around the core(s). The core 205 may be configured to propagate light at one or more desirable wavelengths (e.g., 1310 nm, 1550 nm, etc.) and/or at any desired transmission rate or data rate. The cladding 210 may have a lower index of refraction than that of the core, to facilitate propagation of a signal through the core. An example single mode fiber may have a core diameter between approximately 8 micrometers and approximately 10.5 micrometers with a cladding diameter of approximately 125 micrometers. As another example, a multi-mode fiber may have a core diameter of approximately 50 micrometers or 62.5 micrometers with a cladding diameter of 125 micrometers. Other sizes of fibers may be utilized as desired.

In certain embodiments, one or more protective coatings 215 may be formed on or around the cladding 210. The protective coating(s) may protect the optical fiber 200 from physical, mechanical, and/or environmental damage. For example, the protective coating(s) 215 may protect against mechanical stresses, scratches, and/or moisture damage. In the event that multiple protective coatings are utilized, the coatings may be applied in concentric layers. In certain embodiments, a dual-layer protective coating approach may be utilized. An inner primary coating may be formed around the cladding, and an outer secondary coating may be formed around the inner coating. The outer secondary coating may be harder than the inner primary coating. In this regard, the inner primary coating may function as a shock absorber to minimize attenuation caused by microbending, and the outer secondary coating may protect against mechanical damage and act as a barrier to lateral forces. Other configurations of protective coating(s) may be utilized as desired. Additionally, the protective coating(s) 215 may be formed from a wide variety of suitable materials and/or combinations of materials. A few example materials include, but are not limited to acrylates, acrylate resins, ultraviolet-cured materials, methane acrylate composite materials, etc.

In certain embodiments, one or more optical fibers, such as the optical fiber 200 illustrated in FIG. 2A, may be incorporated into a CTC cable or other cable without any separate buffer layer or tubes. In other embodiments, at least one buffer layer may be formed around an optical fiber. For example, a tight buffer layer may be formed in intimate contact with an underlying layer (e.g., a protective coating, etc.) along a longitudinal length of the optical fiber. In other words, one or more tight buffered optical fibers may be incorporated into a CTC cable or other cable. FIG. 2B illustrates an example optical fiber 220 in which the underlying layers 225 (e.g., core, cladding, one or more protective layers, etc.) or an underlying fiber is surrounded by a tight buffer layer 230. A tight buffer layer 230 may have any suitable thickness and/or may be formed with any suitable outer diameter. In certain example embodiments, a tight buffer layer 230 may have a thickness between approximately 50 microns and approximately 875 microns. Additionally, the tight buffer layer 230 may be formed to have an outer diameter of approximately 200, 250, 300, 400, 500, 600, 700, 800, or 900 microns, an outer diameter included in a range between any two of the above values, or an outer diameter bounded on either a minimum or maximum end by one of the above values.

In other embodiments, one or more optical fibers may be housed within a microtube or other suitable: rube that permits the optical fibers to flex or bend within the tube. Any number of optical fibers may be housed within a suitable tube, such as one, two, three, four, eight, twelve, or some other number of optical fibers. Additionally, a tube may be formed with a single layer or multi-layer construction from any suitable material or combination of materials. FIG. 2C illustrates an example optical fiber configuration 240 in which a single fiber 245 is positioned within a buffer tube 250 or other suitable tube. In other embodiments, a plurality of optical fibers may be positioned within a loose buffer tube. FIG. 2D illustrates an example configuration 260 in which a plurality of optical fibers 265A-D are positioned within a microtube 270 or other tube. In certain embodiments, a microtube or other tube may have an inner diameter that is sized to allow optical fibers to move relative to one another while preventing the optical fibers from crossing over or overlapping one another. In other words, a microtube may permit a plurality of optical fibers to flex or move as the cable is flexed or bent while simultaneously maintaining the position of each optical fiber relative to the other optical fibers. In certain embodiments, an inner diameter of the microtube 270 may be determined based at least in part on the number of optical fibers to be positioned within the microtube 270 and/or the outer diameters of the optical fibers. A wide variety of other suitable tubes or other structures may be utilized as desired to house one or more optical fibers.

Additionally, a wide variety of suitable materials and/or combinations of materials may be utilized to form a buffer layer (e.g., a tight buffer layer, etc.) or tube (e.g., a loose tube, a microtube, etc.). For example, a buffer layer or tube may be formed from one or more suitable polymeric materials and/or thermoplastic materials. Examples of suitable materials include, but are not limited to polypropylene (“PP”), polyvinyl chloride (“PVC”), a low smoke zero halogen (“LSZH”) material, polyethylene (“PE”), nylon, polybutylene terephthalate (“PBT”), polyvinylidene fluoride (“PVDF”), fluorinated ethylene propylene (“FEP”), polyimide (e.g., thermoplastic polyimide, etc.), etc. In certain embodiments, a polymeric material may include a single material component or a mixture of various components. Additionally, in certain embodiments, a buffer layer or tube may be formed with a single layer. In other embodiments, a buffer layer or tube may include a plurality of layers, such as a plurality of co-extruded or successively extruded layers. In the event that a plurality of layers are utilized, in certain embodiments, each layer may be formed from the same or from similar materials. In other embodiments, at least two layers may be formed from different materials. In one example embodiment, one or more tight buffered optical fibers having polyimide tight buffers with an outer diameter of approximately 200 to 400 microns (e.g., a tight buffer with a diameter of 200, 250, 300, 350, or 400 microns, etc.) may be incorporated into a CTC cable or other cable. Further, any descriptions herein of optical fibers incorporated into a separator are equally applicable to optical fiber components that may be incorporated into a separator. As desired, a suitable armor layer (e.g., dielectric armor, metal armor, etc.) may be formed around an optical fiber and/or incorporated into an optical fiber component in order to provide mechanical protection for the optical fiber. For example, an armor layer may be formed around an optical fiber or formed around a buffer layer (e.g., a tight buffer, a tube, etc.).

Additionally, in certain embodiments, one or more optical fibers may be incorporated into the CTC cable or other cable to allow for a desired amount of excess fiber length. For example, an optical fiber or tightly buffered optical fiber may be positioned within a cable such that excess fiber length is provided. As another example, excess fiber length may be provided within a tube or other fiber housing that is incorporated into the cable. The excess fiber length may facilitate bending of the one or more fibers, for example, when a winding is formed from a CTC cable. Excess fiber length may also facilitate termination of the one or more fibers to a wide variety of suitable monitoring equipment once the cable is incorporated into a transformer or other application.

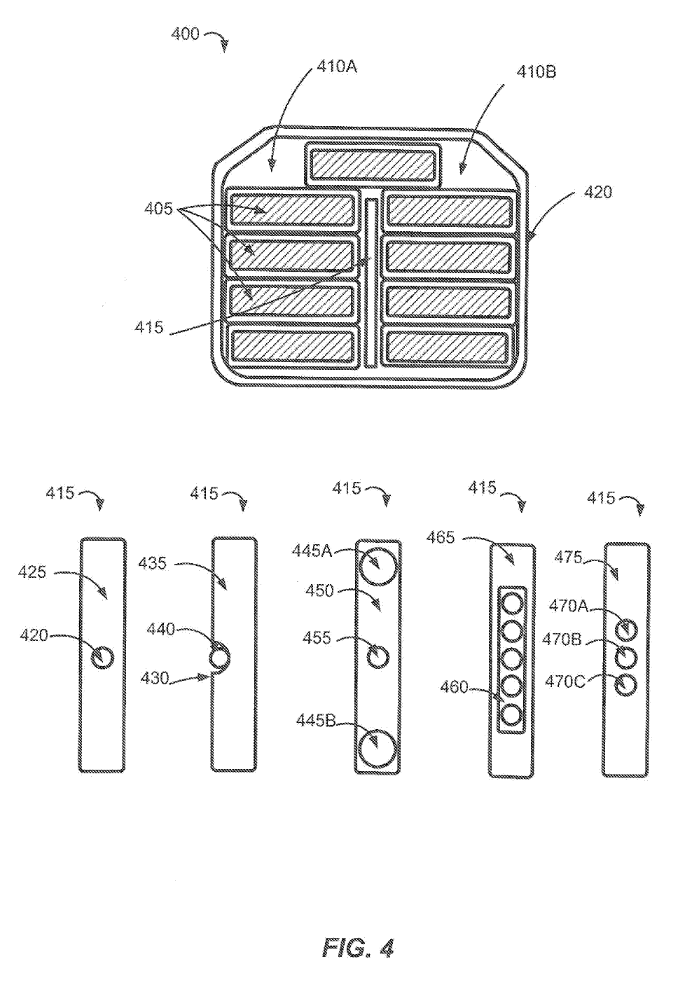

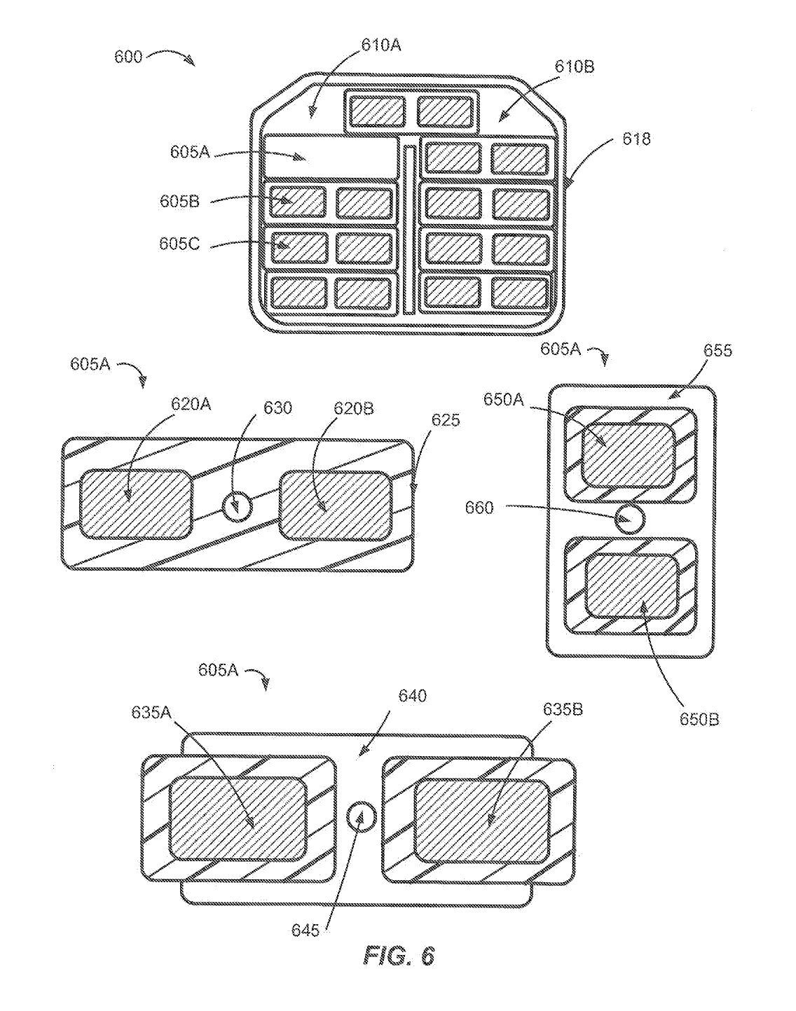

With continued reference to FIG. 1, one or more optical fibers 125 may be incorporated into a CTC cable 100 at a wide variety of suitable locations or positions. FIGS. 3A-6 illustrate a few example configurations or arrangements for incorporating one or more optical fibers 125 into a CTC cable 100. As shown in FIG. 1, and described in greater detail below with reference to FIGS. 3A and 3B, in certain embodiments, one or more optical fibers 125 may be positioned under or within an outer wrap 120 or sheath formed around the CTC cable 100. In other embodiments, as described in greater detail below with reference to FIG. 4, one or more optical fibers 125 may be positioned between the two stacks 110A, 110B in the CTC cable 100, for example, within the separator 115. In yet other embodiments, as described in greater detail below with reference to FIGS. 5 and 6, one or more optical fibers 125 may be incorporated into one or more strands 105 of the CTC cable 100. For example, an optical fiber may be incorporated into a single-conductor or into a multi-conductor strand. Any of the arrangements discussed in greater detail below with reference to FIGS. 3A-6 are equally applicable to the example CTC cable 100 illustrated in FIG. 1, as well as to a wide variety of other suitable CTC cables.

The CTC cable 100 illustrated in FIG. 1 may be suitable for incorporation into a wide variety of suitable electrical devices. For example, the CTC cable 100 may be suitable for incorporation into an electrical transformer, an electric motor, an electric generator, and/or any other rotating electric machine. Additionally, the CTC cable 100 described above with reference to FIG. 1 is provided by way of example only. A wide variety of alternatives could be made to the illustrated cable 100 as desired in various embodiments. For example, a different number of strands, different types of strands, and/or a different strand configuration may be formed. As another example, one or more optical fibers 125 may be positioned at a wide variety of locations. Other suitable CTC cables may include more or less components than the CTC cable 100 of FIG. 1, as well as components situated in other suitable arrangements.

As set forth above, one or more optical fibers may be positioned at a wide variety of suitable locations and/or in accordance with a wide variety of suitable arrangements within a CTC cable. FIGS. 3A-6 illustrate a few example CTC cables having one or more optical fibers positioned in different locations. FIG. 3A is a cross-sectional view of a first example CTC cable 300 that includes an optical fiber. The CTC cable 300 may include similar components as the CTC cable 100 illustrated in FIG. 1. For example, a plurality of strands 305 may be arranged in two stacks 310A, 310B, and strands may be transposed between the two stacks 310A, 310B. An optional separator 315 may be positioned between the stacks, and an outer wrap or sheath 320 maybe formed around the two stacks 310A, 310B.

Similar to the CTC cable 100 illustrated in FIG. 1, the CTC cable 300 illustrated in FIG. 3A may include one or more optical fibers 325 positioned within or under the outer sheath 320. In certain embodiments, the optical fiber(s) 325 may be positioned adjacent to one or more stacks 210A, 210B. For example, as shown in FIG. 3A, the optical fiber(s) 325 may be positioned on the side of a stack 310B under the outer sheath 320. The outer sheath 320 may assist in maintaining the position of the optical fiber(s) 325.

Additionally, during the transposition of strands 305 in a CTC cable 300, strands are typically transposed between stacks 310A, 310B at the top and/or bottom of the stacks 310A, 310B. With each transposition, other strands may be shifted towards either the top or bottom of their stacks 310A, 310B. For example, strands in a first stack 310A may be shifted upward towards the top of the first stack 310A while strands in a second stack 310B may be shifted downward towards the bottom of the second stack 310B. With this or a similar transposition and/or shifting arrangement, one or more optical fibers 325 positioned proximate to a side of stack (e.g., stack 310B) will not be transposed between the two stacks 310A, 310B. In certain embodiments, the optical fiber(s) 325 may be positioned proximate to a stack 310B subsequent to a transposition process. For example, the optical fiber(s) 325 may be fed from a suitable source (e.g., a bin, a reel, etc.) and brought adjacent to a stack 310B at a given point along a longitudinal length of the CTC cable 300 after transposition equipment (e.g., a transposition head, etc. ) has operated on the CTC cable 300 but prior to the formation of an outer sheath 320.

FIG. 3B illustrates another example CTC cable 350 having strands 355 formed into two stacks 360A, 360B and an outer sheath 370 formed around the stacks 360A, 360B. However, FIG. 3B illustrates one or more optical fibers 375 that are positioned under the outer sheath 370 at a position on the top of the CTC cable 350 rather than on the side of a stack. In certain embodiments, the optical fiber(s) 375 may be positioned subsequent to a transposition process. Optical fibers may be positioned at other locations under an outer sheath as desired in other embodiments, such as on opposite sides of the stacks and/or on the bottom of a CTC cable.

In other embodiments, optical fiber(s) may be embedded or otherwise incorporated into an outer sheath. For example, an optical fiber may be embedded in an extruded outer sheath. In other embodiments, an optical fiber may be positioned between two layers of an outer sheath. In yet other embodiments, an optical fiber may be adhered or otherwise affixed to an inner surface of an outer sheath. Indeed, a wide variety of suitable methods and/or techniques may be utilized to position, an optical fiber under or within an outer sheath.

FIG. 4 is a cross-sectional view of another example CTC cable 400 that includes one or more optical fibers. The CTC cable 400 may include similar components as the CTC cable 100 illustrated in FIG. 1. For example, a plurality of strands 405 may be arranged in two stacks 410A, 410B, and strands may be transposed between the two stacks 410A, 410B. Additionally, a suitable separator 415 may be positioned between the stacks and, optionally, an outer wrap or sheath 420 may be formed around the two stacks 410A, 410B. Additionally, at least one optical fiber may be embedded, incorporated into, adhered to, affixed to, or otherwise associated with the separator 415.

A wide variety of suitable methods or techniques may be utilized to associate or incorporate one or more optical fibers into the separator 415. A few example separators 415 that incorporate one or more optical fibers are illustrated in FIG. 4. Any of the illustrated example separators, as well as other separator designs may be incorporated into a CTC cable. As one alternative, at least one optical fiber 420 may be embedded into the separator 415. For example, an optical fiber 420 may be embedded in an extruded separator body 425. In other embodiments, an optical fiber may be positioned between two sections of a separator 415. For example, an optical fiber may be positioned approximately at a cross-sectional midpoint between the two stacks 410A, 410B, and respective separator portions or sections may be positioned on either side of the optical fiber (e.g., above and below). In yet other embodiments, an optical fiber may be positioned between two layers of a separator 415.

As another alternative, a separator 415 may include one or more grooves or channels 430 formed into a surface of a separator body 435. One or more optical fibers 440 may then be positioned within respective groove(s) 430. As desired, an optical fiber 440 may be adhered to the separator 415 within a groove 430. In other embodiments, an optical fiber may be adhered or otherwise affixed to a surface of a separator 415 that does not include any grooves. For example, an optical fiber may be adhered to a top or bottom of a separator 415, or between two portions or sections of a separator 415.

As another alternative, a separator 415 may include one or more strength members, such as the two illustrated strength members 445A, 445B, embedded into a body 450 of the separator 415. One or more optical fibers 455 may also be embedded into the separator body 450. In certain embodiments, the strength members 445A, 445B may have a diameter or other dimensions that are greater than that of the one or more optical fibers 455. As a result, the strength members 445A, 445B may provide mechanical protection for the optical fibers 445.

The separator alternatives described above illustrate single optical fibers that have been incorporated into the separator 415. In other alternatives, a plurality of optical fibers may be incorporated into or otherwise associated with a separator 415. For example, an optical fiber ribbon 465 may be embedded into a separator body 465 or positioned within a groove or channel formed with a separator body 465. As another example, a plurality of individual optical fibers 470A, 470B, 470C may be embedded into a separator body 475 or positioned within respective grooves or channels formed within a separator body 465. Indeed, a wide variety of suitable methods and/or techniques may be utilized to position one or more optical fibers between the two stacks 410A, 410B and/or to associate the optical fiber(s) with a separator 415. In other embodiments, one or more optical fibers may be positioned between the two stacks 410A, 410B without the use of a separator in the CTC cable 400.

FIG. 5 is a cross-sectional view of another example CTC cable 500 that includes one or more optical fibers. The CTC cable 500 may include similar components as the CTC cable 100 illustrated in FIG. 1. For example a plurality of strands (e.g., strands 505A-C, etc.) may be arranged in two stacks 510A, 510B, and strands may be transposed between the two stacks 510A, 510B. As desired, a suitable separator 515 may be positioned between the stacks and/or an outer wrap or sheath 520 may be formed around the two stacks 510A, 510B. With continued reference to FIG. 5, a respective optical fiber may be incorporated into at least one strand 505A of the CTC cable 500. Any number of strands may include one or more respective optical fibers. Additionally, an optical fiber may be incorporated into a strand 505A at a wide variety of suitable positions.

A few alternative example strands 505A that incorporate an optical fiber are illustrated in FIG. 5. As one alternative, a strand 505A may include a conductor 525 and insulation 530 formed around the conductor 525. Additionally, an optical fiber 535 may be embedded in or encapsulated by the insulation 530. For example, an optical fiber 535 may be embedded in extruded insulation. As another alternative, a strand 505A may include a conductor 540 with a plurality of layers of insulation material formed around the conductor 540. For example, base insulation 545, such as one or more enamel layers, may be formed around the conductor 540. A topcoat 550, such as an extruded topcoat, may then be formed around the base insulation 545. Any number of layers and/or types of insulation may be formed around the conductor 540 as desired. Additionally, an optical fiber 560 may be embedded or encapsulated in at least one layer of insulation, such as in the topcoat 550. Alternatively, an optical fiber 560 may be positioned between two layers of insulation.

Regardless of the number of insulation layers, a wide variety of suitable methods and/or techniques may be utilized to embed an optical fiber within an insulation layer or between insulation layers. For example, a conductor 525, 540 may be provided. In certain embodiments, an optical fiber may be positioned adjacent to the conductor, and insulation may then be formed around the conductor and the optical fiber. In other embodiments, insulation may be extruded or otherwise formed in order to encapsulate the optical fiber. For example, an optical fiber may be positioned and an extruded insulation layer may encompass or entrap the optical fiber. In yet other embodiments, an optical fiber may be positioned adjacent to a conductor on which one or more base layers of insulation have been formed. Additionally insulation may then be formed in order to encapsulate the optical fiber.

With continued reference to FIG. 5, another alternative strand 505A is illustrated in which a conductor 570 is surrounded by one or more insulation layers 575. Additionally, an optical fiber 580 may be embedded in the conductor 570. For example, a groove 585 or channel may be formed in a surface of the conductor 570, and the optical fiber 580 may be positioned within the groove 585. As another example, an optical fiber 580 may be impressed into the conductor 570 prior to the conductor 570 cooling into a solid state. In other embodiments, an optical fiber may be encapsulated into the conductor. For example, a channel or cavity may be formed through the conductor, and an optical fiber may be positioned within the channel or cavity. As another example, a conductor may be extruded or otherwise formed around an optical fiber. A wide variety of other suitable techniques may be utilized as desired to incorporate an optical fiber into a strand 505A. The techniques discussed herein are provided by way of example only.

FIG. 6 is a cross-sectional view of another example CTC cable 600 that includes one or more optical fibers. The CTC cable 600 may include similar components as the CTC cable 100 illustrated in FIG. 1. For example, a plurality of strands (e.g., strands 605A-C, etc.) may be arranged in two stacks 610A, 610B, and strands may be transposed between the two stacks 610A, 610B. As desired, a suitable separator 615 may be positioned between the stacks and/or an outer wrap or sheath 618 may be formed around the two stacks 610A, 610B. In certain embodiments, one or more of the strands 605A-C may be formed as a multi-conductor strand as described in greater detail above with reference to FIG. 1. Additionally, at least one optical fiber may be incorporated into at least one strand 605A of the CTC cable 600. Any number of strands may include one or more respective optical fibers. As desired in various embodiments, an optical fiber may be incorporated into a strand 605A at a wide variety of suitable positions and/or in accordance with a wide variety of suitable techniques.

A few alternative example multi-conductor strands 605A that incorporate an optical fiber are illustrated in FIG. 6. As one alternative, a strand 605A may include a plurality of conductors 620A, 620B, and insulation may 625 be formed around the plurality of conductors 620A, 620B such that each conductor 620A, 620B is individually insulated. For example, an extruded insulation layer may be formed between and around the conductors 620A, 620B. Additionally, at least one optical fiber 630 may be embedded or incorporated into the insulation 625. In other embodiments, a respective optical fiber may be embedded in at least one of the conductors in a similar manner as that described above with reference to FIG. 5.

As another alternative, a strand 605A may include a plurality of individually insulated conductors 635A, 635B that are arranged next to each other, for example, in a side by side configuration. Additionally, a bonding layer 640 may be utilized to bond the two insulated conductors 635A, 635B together. For example, a bonding layer 640 may be formed between and at least partially around the insulated conductors 635A, 635B. At least one optical fiber 640 may be embedded or incorporated into the bonding layer 640. As yet another alternative, a strand 605A may include a plurality of individually insulated conductors 650A, 650B that are arranged in a flat by flat or stacked configuration. A bonding layer 655 may be utilized to bond the insulated conductors 650A, 650B together. For example, a bonding layer 655 may be formed between and at least partially around (illustrated as formed completely around) the insulated conductors 650A, 650B. Additionally, at least one optical fiber 660 may be embedded or incorporated into the bonding layer 655. Alternatively, with conductors joined by a bonding layer to form a strand 605A, a respective optical fiber may be embedded into at least of the conductors in a similar manner as that described above with reference to FIG. 5. Further, although the example multi-conductor strands 605A of FIG. 6 are illustrated as having two conductors, any other suitable number of conductors may be incorporated into a strand. In yet other embodiments, a suitable sheath or wrap (e.g., an extruded jacket layer, a tape wrap, etc.) may be formed around a plurality of insulated conductors in order to form a multi-conductor strand. One or more optical fibers may be incorporated into the sheath (e.g., within an extruded layer) and/or into one or more of the conductors. As desired, a wide variety of insulation, bonding layer, and multi-conductor configurations may incorporate at least one optical fiber. The alternative strands illustrated in FIG. 6 are provided by way of non-limiting example only.

The example CTC cables 300, 350, 400, 500, 600 illustrated in FIGS. 3A-6 are provided by way of non-limiting example only. A wide variety of other CTC cables may be formed in accordance with various embodiments that include or incorporate one or more optical fibers. These CTC cable may include more or less components than the CTC cables 300, 350, 400, 500, 600 illustrated in FIGS. 3A-6. Additionally, one or more optical fibers may be incorporated at a wide variety of suitable positions within a CTC cable. For example, a combination of the optical fiber positions illustrated in FIGS. 3A-6 may be utilized in a CTC cable.

Although CTC cables are illustrated in FIGS. 1-6, it will be appreciated that one or more optical fibers may be incorporated into a wide variety of other suitable conductors and/or cables suitable for use in a transformer or other electrical device. For example, many transformers include a primary winding, pancake winding, or disc winding, that is formed from a standalone conductor or from two conductors. A CTC cable is then typically used to form a secondary winding in a transformer. As desired, one or more optical fibers may be incorporated into the non-CTC conductor(s) and/or conductor cable(s) that are utilized in conjunction with transformers and/or other electrical devices, thereby permitting various monitoring and/or sensing.

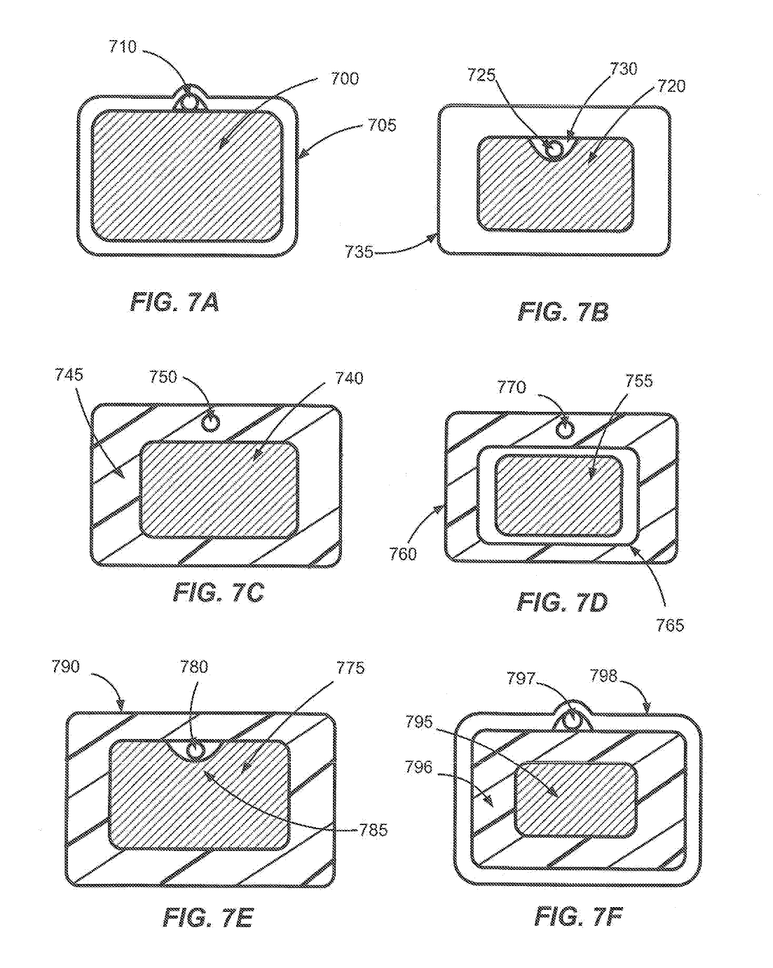

A wide variety of suitable methods and/or techniques may be utilized as desired to incorporate one or more optical fibers into a standalone or two conductor component. FIGS. 7A-7F illustrate a few example conductors that include at least one optical fiber and that may be utilized within a transformer. FIG. 7A illustrates a first example conductor 700 that may be formed as an uninsulated or bare conductor. Similar to the conductors discussed in greater detail above with reference to FIG. 1, the conductor 700 may be formed from a wide variety of suitable materials and/or with a wide variety of suitable dimensions. Additionally, an outer wrap or sheath 705 may be formed around the conductor 700. Similar to the outer wraps discussed above with reference to FIG. 1, the outer wrap 705 may be formed from a wide variety of suitable materials and with a wide variety of suitable dimensions. Additionally, at least one optical fiber 710 may be positioned under the outer wrap 705. In other embodiments, at least one optical fiber may be embedded in the outer wrap or positioned between two layers of the outer wrap.

FIG. 7B illustrates another example conductor 720 that may be formed as an uninsulated or bare conductor. An optical fiber 725 may be positioned within a groove or channel 730 formed in the conductor. An outer wrap 735 may then be formed around the conductor 720. In other embodiments, an optical fiber may be embedded in the conductor. FIG. 7C illustrates another example conductor 740 that may include at least one optical fiber. Insulation 745, such as extruded insulation, may be formed around the conductor 740. Additionally, an optical fiber 750 may be embedded in or encapsulated by the insulation 745. FIG. 7D illustrates another example conductor 755 that includes a plurality of layers of insulation material. For example, base insulation 760, such as one or more enamel layers, may be formed around the conductor 755. A topcoat 760, such as an extruded topcoat, may then be formed around the base insulation 760. Any number of layers and/or types of insulation may be formed around the conductor 755 as desired. Additionally, an optical fiber 770 may be embedded or encapsulated in at least one layer of insulation, such as in the topcoat 760. Alternatively, an optical fiber may be positioned between two layers of insulation.

FIG. 7E illustrates another example insulated conductor 775. Similar to the conductor 720 of FIG. 7B, an optical fiber 780 may be positioned within a groove or channel 785 formed in the conductor 775. Insulation may then be formed around the conductor 775 and the optical fiber 780. In other embodiments, an optical fiber may be embedded within an insulated conductor. FIG. 7F illustrates another example conductor 795 that is surrounded by suitable insulation 796. An optical fiber 797 may be positioned adjacent to the insulated conductor or within a groove formed in the insulation. A suitable outer wrap 798 may then be positioned around the insulated conductor and the optical fiber 797.

A wide variety of other standalone or single conductor embodiments may incorporate one or more optical fibers. The example conductors illustrated in FIGS. 7A-7F are provided by way of example only. Additionally, one or more optical fibers may be incorporated into a wide variety of electrical device windings that include two (or more) conductors. For example, a respective optical fiber may be incorporated into one or more of the conductors. As another example, an optical fiber may be incorporated into a joining coating formed between and/or around the conductors in a similar manner as that described above with reference to FIG. 6.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations, are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A continuously transposed conductor (CTC) cable comprising:
a plurality of electrically insulated strands formed into two interposed stacks and connected in parallel at their ends; and
an optical fiber.

2. The cable of claim 1, further comprising:
an outer wrap formed around the plurality of electrically insulated strands,
wherein the optical fiber is positioned between the outer wrap and the plurality of electrically insulated strands.

3. The cable of claim 1, further comprising:
an outer wrap formed around the plurality of electrically insulated strands, the outer wrap comprising at least two layers,
wherein the optical fiber is positioned between the at least two layers of the outer wrap.

4. The cable of claim 1, further comprising:
a separator positioned between the two interposed stacks,
wherein the optical fiber is embedded in the separator.

5. The cable of claim 1, further comprising:
a separator positioned between the two interposed stacks, the separator comprising a longitudinally extending groove,
wherein the optical fiber is positioned in the groove.

6. The cable of claim 1, wherein at least one of the plurality of strands comprises:
a conductor; and
an insulation layer formed around the conductor,
wherein the optical fiber is embedded in the insulation layer.

7. The cable of claim 1, wherein at least one of the plurality of strands comprises:
a conductor; and
a plurality of insulation layers formed around the conductor,
wherein the optical fiber is positioned between two of the plurality of insulation layers.

8. The cable of claim 1, wherein at least one of the plurality of strands comprises:
a conductor; and
at least one insulation layer formed around the conductor,
wherein the optical fiber is positioned at least partially within the conductor.

9. The cable of claim 1, wherein at least one of the plurality of strands comprises:
a plurality of conductors; and
an insulation layer formed between and at least partially around an outer periphery of the plurality of conductors,
wherein the optical fiber is embedded in the insulation layer.

10. The cable of claim 1, wherein at least one of the plurality of strands comprises:
a plurality of individually insulated conductors; and
a bonding layer formed between and at least partially around an outer periphery of the
plurality of individually insulated conductor,
wherein the optical fiber is embedded in the bonding layer.

11. The cable of claim 1, wherein each strand successively and repeatedly takes on each possible position within a cross-section of the CTC cable.

12. The cable of claim 1, wherein the optical fiber comprises a tight buffered optical fiber.

13. The cable of claim 12, wherein the tight buffered optical fiber comprises a buffer layer comprising polyimide.

14. The cable of claim 12, wherein the tight buffered optical fiber comprises an outer diameter between approximately 200 and approximately 400 microns.

15. A continuously transposed conductor (CTC) cable comprising:
a plurality of electrically insulated conductors formed into two interposed stacks, each of the plurality of electrically insulated conductors successively and repeatedly taking on each possible position with a cross-section of the CTC cable; and
an optical fiber.

16. The cable of claim 15, further comprising:
an outer wrap formed around the plurality of electrically insulated conductors,
wherein the optical fiber is positioned between the outer wrap and the plurality of electrically insulated conductors.

17. The cable of claim 15, further comprising:
a separator positioned between the two interposed stacks,
wherein the optical fiber is at least partially embedded in the separator.

18. The cable of claim 15, wherein the optical fiber is embedded in the insulation of one of the plurality of electrically insulated conductors.

19. The cable of claim 15, wherein the optical fiber is at least partially embedded within one of the conductors included in the plurality of electrically insulated conductors.

20. The cable of claim 15, wherein the optical fiber comprises a tight buffered optical fiber.
